(19) United States
(12) Patent Application Publication
(10) Pub. No.: US 2015/0111429 A1
(43) Pub. Date: Apr. 23, 2015

(54) GRIPPING SLEEVE WITH INTEGRATED GROUNDING MEMBER FOR ELECTRICAL CONNECTOR

(71) Applicant: Amphenol Corporation, Wallingford, CT (US)

(72) Inventors: Michael Andrew HOYAK, Sandy Hook, CT (US); Rakesh THAKARE, Danville, VA (US); Richard PAGLIA, Springfield, MA (US); Bryan BLUNT, Casa Grande, AZ (US); Weixing CHEN, Changzhou (CN); Minghua GU, Changzhou (CN); Caichun SONG, Changzhou (CN)

(21) Appl. No.: 14/584,532

(22) Filed: Dec. 29, 2014

Related U.S. Application Data
(63) Continuation-in-part of application No. 14/028,355, filed on Sep. 16, 2013.
Application No. 14/028,355 is a continuation-in-part of application No. 13/530,831, filed on Jun. 22, 2012, now Pat. No. 8,808,019.
Application No. 13/530,831 is a continuation of application No. 13/368,047, filed on Feb. 7, 2012, now Pat. No. 8,231,412.
Application No. 13/368,047 is a continuation of application No. 13/286,570, filed on Nov. 1, 2011, now abandoned.
(60) Provisional application No. 61/408,927, filed on Nov. 1, 2010.

(51) Int. Cl. H01R 13/6583; H01R 43/20

(52) U.S. Cl. CPC H01R 13/6583; H01R 43/20
USPC 439/607.17; 29/876

(57) ABSTRACT

A grounding member for an electrical connector that has a conductive body including a ring portion that has opposite front and rear edges, the front edge is configured to face a coupling member of the electrical connector, and opposite inner and outer surfaces, the inner surface is configured to face a body of the electrical connector. At least a first resilient arm that extends from the front edge of the ring portion. The first resilient arm has a coupling member contact surface configured to contact the coupling member of the electrical connector. At least a second resilient arm that extends from the rear edge of the ring portion. The second resilient arm has a body contact surface configured to contact the body of the electrical connector. At least one sleeve engagement member that extends from the ring portion configured to engage a gripping sleeve.

### RELATED APPLICATION

This application is a continuation-in-part of copending commonly owned application Ser. No. 14/028,355, filed Sep. 16, 2013, which is a continuation-in-part of application Ser. No. 13/530,831, filed on Jun. 22, 2012, now U.S. Pat. No. 8,808,019, which is a continuation of application Ser. No. 13/368,047, filed on Feb. 7, 2012, now U.S. Pat. No. 8,231,412, which is a continuation of application Ser. No. 13/286,570, filed on Nov. 1, 2011, now abandoned, which claims priority to Provisional Application Ser. No. 61/408,927, filed Nov. 1, 2010.

### FIELD OF THE INVENTION

The present invention relates to an electrical connector, such as a coaxial cable connector, that has an integrated grounding member and gripping sleeve.

### BACKGROUND OF THE INVENTION

Coaxial cable connectors are typically used to connect a coaxial cable with a mating port or terminal of another device, such as equipment, appliances, and the like. For various reasons, such as movement of the equipment, vibrations, or improper installation of the connector, the connection between the coaxial connector and the mating port often becomes loose. That may result in a poor signal quality and RFI leakage due to the weak connection between the conductors of the mating port and coaxial cable. Therefore, a need exists for an alternative grounding path between those conductors that can compensate for a loose connection between the coaxial connector and its mating port.

Examples of prior art coaxial connectors with a grounding mechanism include U.S. Pat. No. 7,753,705 to Montena and U.S. Pat. No. 7,114,990 to Bence et al., the subject matter of each of which is hereby incorporated by reference.

### SUMMARY OF THE INVENTION

Accordingly, the present invention provides a grounding member for an electrical connector that has a conductive body including a ring portion that has opposite front and rear edges, the front edge is configured to face a coupling member of the electrical connector, and opposite inner and outer surfaces, the inner surface is configured to face a body of the electrical connector. At least a first resilient arm that extends from the front edge of the ring portion. The first resilient arm has a coupling member contact surface configured to contact the coupling member of the electrical connector. At least a second resilient arm that extends from the rear edge of the ring portion. The second resilient arm has a body contact surface configured to contact the body of the electrical connector. At least one sleeve engagement member that extends from the ring portion configured to engage a gripping sleeve.

The present invention may also provide a grounding member and gripping sleeve assembly that includes a sleeve that has front and rear ends and an internal bore with at least one grounding engagement member, and a conductive body. The conductive body includes a ring portion that has opposite front and rear edges, the front edge is configured to face the front end of the sleeve, and opposite inner and outer surfaces. At least a first resilient arm extends from the front edge of the ring portion, the first resilient arm has a first contact surface. At least a second resilient arm extends from the rear edge of the ring portion, and the second resilient arm has a second contact surface. At least one sleeve engagement member extends from the ring portion. The at least one grounding engagement member of the sleeve engages the at least one sleeve engagement member of the conductive body.

The present invention also provides an electrical connector that has a connector body that has opposite first and second ends, the second end is configured to be coupled with a prepared end of a cable, a coupling member that has an interface end configured to interface with a mating connector and an opposite end that is rotatable with respect to said connector body, and a gripping sleeve coupled to an outer surface of the coupling member such that said gripping sleeve and coupling member rotate together. The gripping sleeve has a main body with an internal bore configured to accommodate at least a portion of the coupling member and the connector body, an outer surface that provides a gripping area portion, and an inner surface opposite the outer surface. A conductive grounding member is received in the internal bore of the gripping sleeve. The grounding member includes a ring portion that has opposite first and second edges, the first edge facing the coupling member, and opposite inner and outer surfaces, the inner surface facing the connector body. At least a first resilient arm extends from the first edge of the ring portion. The first resilient arm has a coupling member contact surface contacting the coupling member. At least a second resilient arm extends from the second edge of the ring portion. The second resilient arm has a body contact surface contacting the connector body. The grounding member creates a grounding path between the connector body and the coupling member.

The present invention may yet further provide a method of assembling an electrical connector that includes the steps of providing an electrical connector that has a connector body and a coupling member rotatable with respect to the connector body; providing a gripping sleeve including an internal bore that is configured to receive a portion of the connector body and the coupling member, the internal bore includes at least one engagement member, and the gripping sleeve includes opposite front and rear ends; and providing a conductive grounding member that includes a ring portion that has opposite front and rear edges, the front edge is configured to face a coupling member of the electrical connector, and opposite inner and outer surfaces, the inner surface is configured to face a body of the electrical connector, at least a first resilient arm that extends from the front edge of the ring portion, the first resilient arm has a coupling member contact surface configured to contact the coupling member of the electrical connector, at least a second resilient arm that extends from the rear edge of the ring portion, the second resilient arm has a body contact surface configured to contact the body of the electrical connector, and at least one sleeve engagement member that extends from the ring portion. The method may also include the steps of inserting the grounding member into the rear end of the gripping sleeve until the at least one engagement member of the gripping sleeve interlocks with the at least one sleeve engagement member of the grounding member; inserting the electrical connector into the internal bore of the gripping sleeve such that the grounding member contacts an outer surface of the coupling member and an outer surface of the connector body.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view of an electrical connector in accordance with an exemplary embodiment of the present invention;

FIG. 2 is an exploded perspective view of the electrical connector illustrated in FIG. 1;

FIGS. 3A and 3B are cross-sectional and elevational views, respectively, of a grounding member of the electrical connector illustrated in FIG. 1;

FIG. 4. is a partial cross-sectional view of the electrical connector illustrated in FIG. 1;

FIG. 5 is an enlarged cross-sectional view similar to FIG. 4, showing the location of the grounding member;

FIG. 6 is a perspective view of an electrical connector with an integrated grounding member and gripping sleeve, according to an exemplary embodiment of the present invention;

FIG. 7A is a cross-sectional view of the electrical connector illustrated in FIG. 6, showing an integrated grounding member and gripping sleeve in accordance with a first embodiment of the present invention;

FIG. 7B is a partial enlarged view of the electrical connector illustrated in FIG. 7A;

FIG. 7C is a plan view of a grounding member of the electrical connector illustrated in FIG. 7A;

FIG. 8A is a cross-sectional view of the electrical connector illustrated in FIG. 6, showing an integrated grounding member and gripping sleeve in accordance with a second embodiment of the present invention;

FIG. 8B is a partial perspective view of a sleeve of the electrical connector illustrated in FIG. 8A;

FIG. 8C is a plan view of a grounding member of the electrical connector illustrated in FIG. 8B;

FIG. 8D is a cross-sectional view of the grounding member illustrated in FIG. 8C;

FIG. 9A is a cross-sectional view of the electrical connector illustrated in FIG. 6, showing an integrated grounding member and gripping sleeve in accordance with a third embodiment of the present invention;

FIG. 9B is a perspective view of a sleeve of the electrical connector illustrated in FIG. 9A, showing a grounding member disposed inside of the sleeve;

FIG. 9C is a perspective view of the grounding member illustrated in FIGS. 9A and 9B;

FIG. 10A is a cross-sectional view of the electrical connector illustrated in FIG. 6, showing an integrated grounding member and gripping sleeve in accordance with a fourth embodiment of the present invention;

FIG. 10B is an elevational view of the grounding member illustrated in FIG. 10A;

FIG. 10C is an end view of the grounding member illustrated in FIG. 10B;

FIG. 11A is a cross-sectional view of an electrical connector in accordance with a fifth embodiment of the present invention, showing an integrated grounding member and gripping sleeve;

FIG. 11B is a perspective view of a gripping sleeve of the electrical connector illustrated in FIG. 11A;

FIG. 11C is a cross-sectional view the gripping sleeve and the grounding member of the electrical connector illustrated in FIG. 11A;

FIG. 11D is a perspective view of the grounding member illustrated in FIGS. 11A and 11C;

FIG. 12A is a perspective view of a gripping sleeve according to an exemplary embodiment of the present invention, showing the electrical connector received in the gripping sleeve;

FIG. 12B is an end view of the gripping sleeve illustrated in FIG. 12A;

FIG. 13A is an exploded perspective view of a gripping sleeve according to yet another exemplary embodiment of the present invention, showing the electrical connector being receivable in the gripping sleeve;

FIG. 13B is an exploded end view of the gripping sleeve illustrated in FIG. 13A; and

FIG. 14 is a perspective view of a grounding member according to yet another exemplary embodiment of the present invention;

FIG. 15A is a front end view of a gripping sleeve according to yet another exemplary embodiment of the present invention;

FIG. 15B is a rear end view of the gripping sleeve illustrated in FIG. 15A;

FIG. 16A is a front end perspective view of the assembly of the grounding member and gripping sleeve illustrated in FIGS. 14, 15A, and 15B;

FIG. 16B is a rear end view of the grounding member and gripping sleeve illustrated in FIG. 16A;

FIG. 17 is a perspective view of the grounding member illustrated in FIG. 14, showing the grounding member on the connector with the gripping sleeve removed;

FIG. 18 is a cross-sectional view of the connector illustrated in FIG. 17 along line 18-18, and showing the gripping sleeve; and

FIG. 19 is another cross-sectional view of the connector similar to FIG. 19 along line 19-19 of FIG. 17.

### DETAILED DESCRIPTION OF THE INVENTION

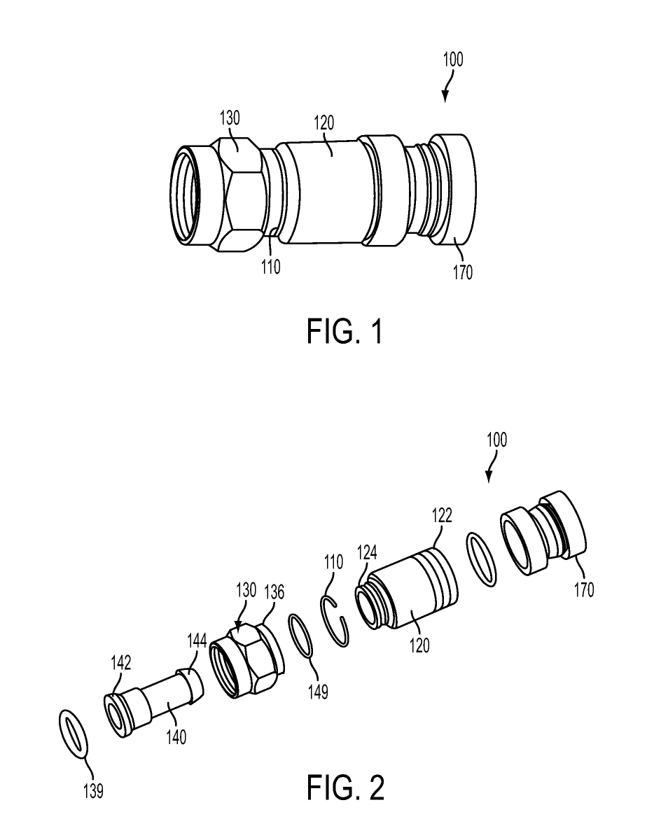

Referring to FIGS. 1, 2, 3A, 3B, 4, and 5, the present invention relates to an electrical connector 100, such as a coaxial connector, that includes a grounding member 110 which insures a continuous grounding path between a cable coupled to the connector 100 and a corresponding mating connector or port (not shown) of a device, such as a television, even if the connection therebetween becomes loose.

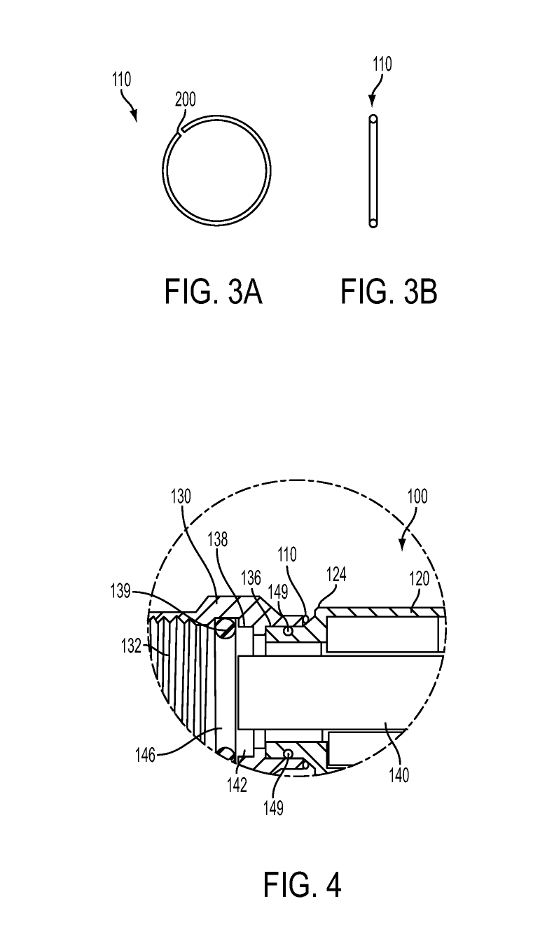

The connector 100 generally includes the grounding member 110, a connector body 120, a coupling member 130, and a post member 140. A compression ring 170 may be provided to facilitate termination of the cable with the connector. The grounding member 110, seen in FIGS. 3A and 3B, is disposed on the outside of the connector 100 to maintain electrical contact between the coupling member 130 and the connector body 120. Due to the grounding member 110, such electrical contact will be maintained even if the connection between the connector 100 and its mating connector or port becomes loose.

The post member 140 has a substantially tubular shape with an enlarged shoulder 142 at one end 146 adapted to couple with the coupling member 130, and an opposite end 144 designed to interface with a prepared end of a coaxial cable (not shown), as is well known in the art. The post member 140 is received in both the connector body 120 and the coupling member 130, as seen in FIG. 1, such that the coupling member 130 rotates with respect to the post member 140 at the end 146, and the connector body 120 engages the post member 140 in a tight or friction fit.

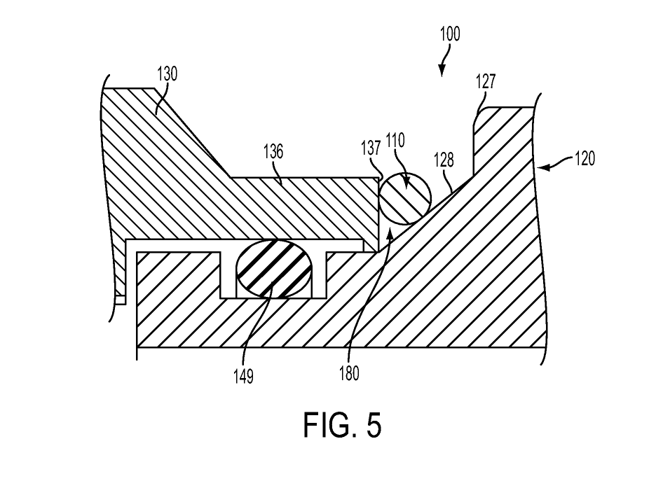

The coupling member 130 is preferably a nut with internal threads 132, as best seen in FIGS. 1 and 2, and is adapted to engage external threads of a mating connector or port. The coupling member 130 includes an interface end 134 which engages the mating connector and an opposite free end 136 with an end face surface 137 (FIG. 5). Near the free end 136 of the coupling member 130 is an internally extending shoulder 138 that catches the enlarged shoulder 142 of the post member 140, thereby rotatably coupling the coupling member 130 to the post member 140. An O-ring 139 is preferably provided inside of the coupling member 130 to prevent moisture migration.

As seen in FIGS. 1 and 2, the connector body 120 is generally tubular in shape with a first end 122 adapted to couple with the prepared end of the cable, as is well known in the art, and a opposite tapered second end 124 that engages the post member 140. At its second end 124, the connector body 120 may include a transition portion 126 that may have a transition shoulder 127 and a tapered surface 128. Alternatively, the transition portion 126 may just have a tapered surface or may be a series of tapered shoulders. The transition portion 126 meets the free end 136 of the coupling member 130, as seen in FIG. 1. A gap 180, as seen in FIG. 5, exists between the transition portion of the connector body 120 and the end face surface 137 of the coupling member 130. That gap 180 may vary due to tolerances in the connector. An O-ring 149 may be provides between the overlap of the free end 136 of the coupling member 130 and the second end 124 of the connector body 120 to prevent moisture migration.

As seen FIGS. 2, 3A and 3B, the grounding member 110 is preferably a ring that is resilient to form a tight fit over the connector body 120 and the coupling nut 130. For example, the grounding member 110 may be a spring coil, wave washer, star washer and the like. Alternatively, the grounding member 110 may be a conductive O-ring. The grounding member 110 may include a cutout portion 200 (FIG. 3A) to facilitate assembly of the grounding member 110 on the connector 100. As seen in FIGS. 4 and 5, the grounding member 110 preferably sits in the gap 180 between the free end 136 of the coupling member 130 and the second end 124 of the connector body 120. In particular, the grounding member 110 may be in contact with adjacent surfaces of the components, that is in contact with the transition portion 126 of the connector body's second end 124 and the end surface of the coupling member's free end 136. Because the grounding member 110 is resilient, it will remain in place and provide a consistent grounding path between the connector body 120 and the coupling member 130. Although, it is preferably that the grounding member 110 be located in the gap 180, the grounding member 110 may be located any outer or exposed surface of the connector body 120 and the coupling member 130 as long as the grounding member is in contact with adjacent surfaces of both components to maintain electrical continuity therebetween.

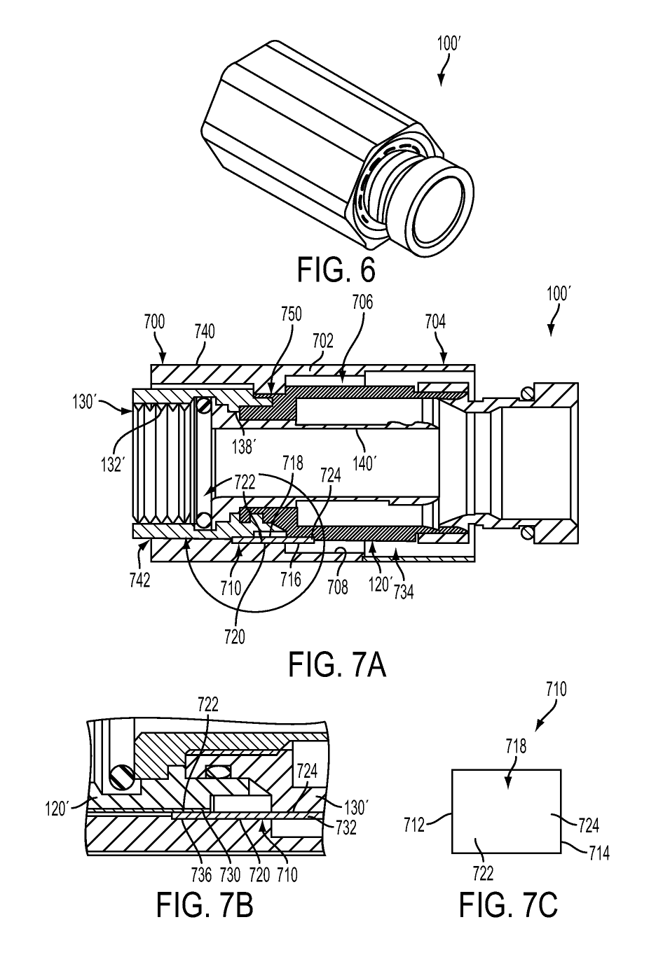

Referring to FIGS. 6 and 7A-7C, an electrical connector 100′ according to another exemplary embodiment of the present invention includes a gripping sleeve 700 that incorporates a grounding area portion, such as a grounding member 710, that functions similarly to grounding member 110 in that it creates a grounding path between the coupling member or nut 130′ and the connector body 120′.

As seen in FIGS. 7A-7C, the grounding member 710 may be integrated with a gripping sleeve 700. The gripping sleeve 700 generally includes a main body 702 that has an outer surface 704 that facilitates gripping of the connector 100′ and an internal bore 706 adapted to receive the connector 100′. The outer surface 704 preferably has a gripping area portion 740 that may be, for example, longitudinal ribs (FIG. 6), knurls, and the like. The internal bore 706 includes a first end 742 that engages the coupling member or nut 130′ of the connector 100′ such that the gripping sleeve 700 and the nut 130′ rotate together. The first end 742 of the bore 706 may be shaped to substantially match the shape of the nut 130′ such that an interference fit is formed therebetween, for example. The second end 734 of the internal bore 706 accommodates at least some or all of the connector body 120′ of the connector 100′.

The internal bore 706 of the gripping sleeve 700 includes an inner surface 708 that preferably has a grounding area portion that contacts both the nut 130′ and the connector body 120′ when the gripping sleeve 700 is installed on the electrical connector 100′ to provide the grounding path. The grounding area portion is preferably the grounding member 710 disposed on the inner surface 708. In a preferred embodiment, the grounding member 710 sits in a recessed area 736 of the inner surface 708. The grounding member 710 may be secured to the inner surface 708 by any known manner, such as molding the sleeve 700 with the grounding member 710, by interlocking, by press-fit, by adhesive or the like.

The grounding member 710 may be a conductive or metal segment (FIG. 7C) that generally includes first and second ends 712 and 714 and opposite first and second sides 716 and 718. The first side 716 of the metal segment 710 includes a sleeve engaging surface 720. The opposite second side 718 includes both a nut contact surface 722 near the first end 712 and a body contact surface 724 near the second end 714. The nut and body contact surfaces 722 and 724 are preferably substantially co-planar with respect to one another and engage outer surfaces of the nut 130′ and the connector body 120′. However, the surfaces 722 and 724 may also not be co-planar. An outer surface of the nut 130′ may be any surface of the nut 130′ that is not inside the nut 130′, such as at the internal threads 132′ and/or internally extending shoulder 138′. An outer surface of the body 120′ is any surface of the body 120′ that is not on the inside of the body 120′ where the post 140′ is received in the body 120′. The length of the grounding member 710 should be long enough to contact both the nut 130′ and the body 120′. In this embodiment, the nut contact surface 722 engages an outer surface 730 of the nut 130′ and the body contact surface 724 engages an outer surface 732 of the connector body 120′, as best seen in FIG. 7B. Although only one grounding member 710 is illustrated in FIGS. 7A-7C, more than one grounding member 710 may be provided on the inner surface 708 of the sleeve 700.

The gripping sleeve 700 may optionally include a retaining member 750 in the internal bore 706, as seen in FIG. 7A. The retaining member 750 may be an internally extending annular flange, for example, that preferably extends in the gap between the nut 130′ and the connector body 120′ when the sleeve 700 is installed on the connector. The retaining member 750 generally prevents axial movement of the sleeve with respect to the connector 100′, thereby generally preventing the sleeve from slipping off of the connector. The flange 750 may extend continuously around the internal bore 706 of the sleeve 700 or may be discontinuous to form a plurality of ledges extending into the bore 706.

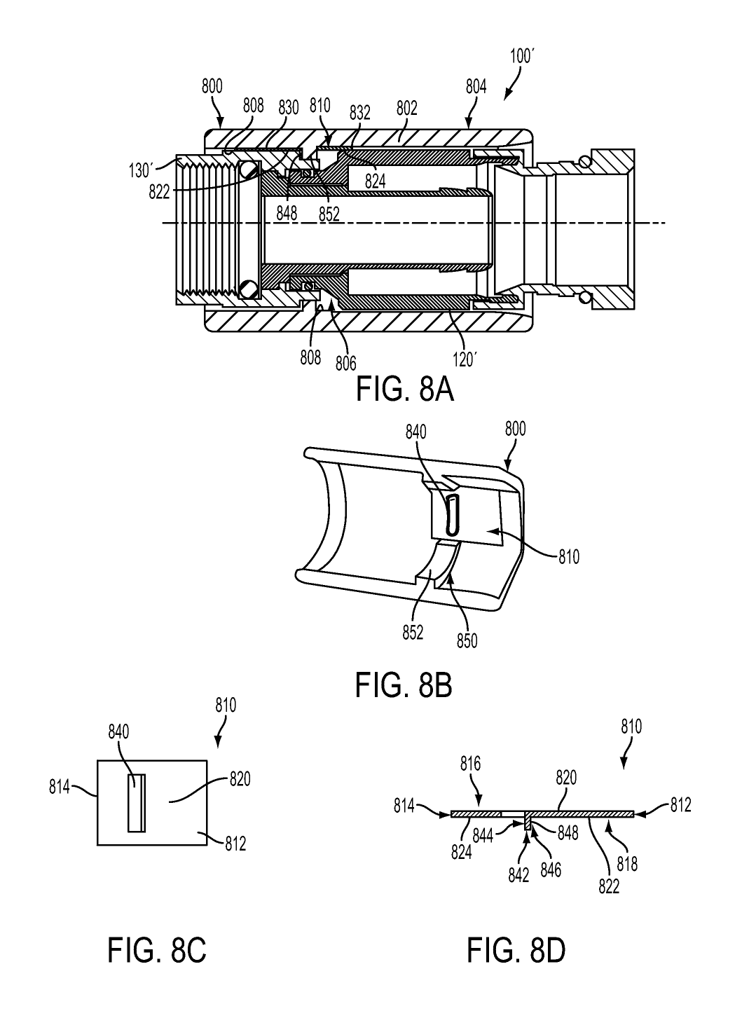

FIGS. 8A-8C illustrate a second embodiment of a gripping sleeve 800 and a grounding member 810 integrated therein. The sleeve 800 and the grounding member 810 are similar to sleeve 700 and grounding member 710 of the first embodiment in that the sleeve 800 facilitates gripping and torque of the connector 100′ and that the grounding member 810 provides a conductive path between the nut 130′ and the body 120′.

Like the gripping sleeve 700 of the first embodiment, the gripping sleeve 800 generally includes a main body 802, an outer surface 804 that facilitates gripping of the connector 100′ and an internal bore 806 adapted to receive the connector 100′. The internal bore 806 of the gripping sleeve 800 includes an inner surface 808 that has the grounding area portion or grounding member 810. The gripping sleeve 800 preferably includes a retaining member 850 that may be a flange around the inner surface 808 of the sleeve 800. The flange 850 is preferably discontinuous to form a plurality of ledges 852.

The grounding member 810 may be a conductive or metal segment (FIG. 8C) similar to the grounding member 710 of the first embodiment and generally includes first and second ends 812 and 814 and opposite first and second sides 816 and 818. The grounding member 810 may include a cut-out section 840 (FIG. 8C) with a leg section 842 (FIG. 8D) extending therefrom. The leg section 842 may be substantially perpendicular to the main portion of the grounding member 810. The first side 816 includes a sleeve engaging surface 820 and the cut-out section 840 is shaped to receive one of the ledges 852 (FIG. 8B) on the inner surface 808, thereby holding the grounding member 810 in the internal bore 806. The grounding member 810 may also be molded with the sleeve 800, press-fit or adhered to the sleeve 800.

The opposite second side 818 of the grounding member 810 includes both a primary nut contact surface 822 near the first end 812 and a body contact surface 824 near the second end 814. The nut and body contact surfaces 822 and 824 are preferably substantially co-planar with respect to one another and engage outer surfaces of the nut 130′ and the connector body 120′. However, the surfaces 822 and 824 may also not be co-planar. The length of the grounding member 810 should be long enough to contact both the nut 130′ and the body 120′. In this embodiment, the primary nut contact surface 822 engages an outer surface 830 of the nut 130′ and the body contact surface 824 engages an outer surface 832 of the connector body 120′, as best seen in FIG. 8A.

The leg section 842 of the grounding member 810 has opposite faces 844 and 846, as seen in FIG. 8D. One face 844 may be adjacent to or contact the ledge 852 of the sleeve 800 that is extending through the cut-out section 840 of the grounding member 810. The opposite face 846 may include a secondary nut contact surface 848 (FIG. 8A) that engages the outer surface 830 of the nut 130′ at a location spaced from where the primary nut contact surface 822 engages the nut 130′. For example, the primary nut contact surface 822 may engage the gripping area of the nut's outer surface 830 and the secondary nut contact surface 848 may engage the end face of the nut's outer surface 830.

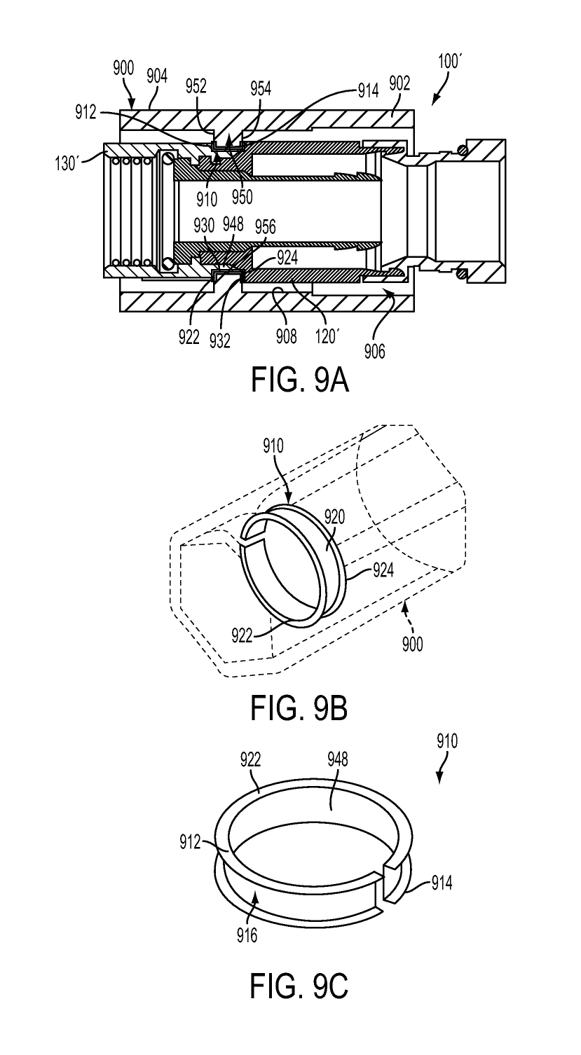

FIGS. 9A-9C illustrate a third embodiment of a gripping sleeve 900 and a grounding member 910 integrated therein similar in function to the first and second embodiments in providing a grounding path between the nut 130′ and the body 120′.

Gripping sleeve 900 generally includes a main body 902, an outer surface 904 that facilitates gripping of the connector 100′ and an internal bore 906 with an inner surface 908 adapted to receive the connector 100′. The gripping sleeve 900 may include a retaining member 950 that is preferably an annular flange extending around the inner surface 908 of the sleeve 900. Although it is preferable that the flange 950 extends continuously around the inner surface 908, the flange 950 may be discontinuous. The flange 950 may have opposite radially extending faces 952 and 954 and an annular inner surface 956 therebtween. The flange 950 preferably extends into the gap between the body 120′ and the nut 130′ when the sleeve 900 is installed on the connector. The flange 950 preferably has a grounding area portion that supports the grounding member 910, as seen in FIG. 9A.

The grounding member 910 is formed of a conductive material and may include a resilient ring body 916 (FIG. 9C) with first and second walls 912 and 914 extending therefrom, thereby forming a generally U-shaped cross-section. The ring body 916 includes a sleeve engaging surface 920 that rests on the annular inner surface 956 of the sleeve's flange 950. The first and second walls 912 and 914 extend along the opposite faces 952 and 954, respectively, such that the flange 950 is received in the U-shaped cross-section of the grounding member 910. The grounding member 910 is held on the flange 950 in any known manner, such as overmolding, interlocking, press-fit, adhesive, and the like.

The first wall 912 of the grounding member 910 includes a primary nut contact surface 922 near on the outside thereof such that when the sleeve 900 is installed on the connector, the first wall 912 is sandwiched between the free end of the nut 130′ and the sleeve's flange 950. The second wall 914 of the grounding member 910 includes a body contact surface 924 on the outside thereof such that the second wall 914 is sandwiched between the outer surface of the connector body 120′ and the flange 950. The width or length of the flange 950 and the grounding member 910 is sized so that the when fitted in the gap, positive contact is made between the primary nut contact surface 922 and the outer surface 930 of the nut 130′ and between the body contact surface 924 and the outer surface 932 of the body 120′, as best seen in FIG. 9A.

A secondary nut contact surface 948 may be provided on the outside of the ring body 916 that engages the outer surface of the nut 130′ at its free end. The second nut contact surface 948 is preferably spaced from and substantially perpendicular with respect to the primary nut contact surface 922.

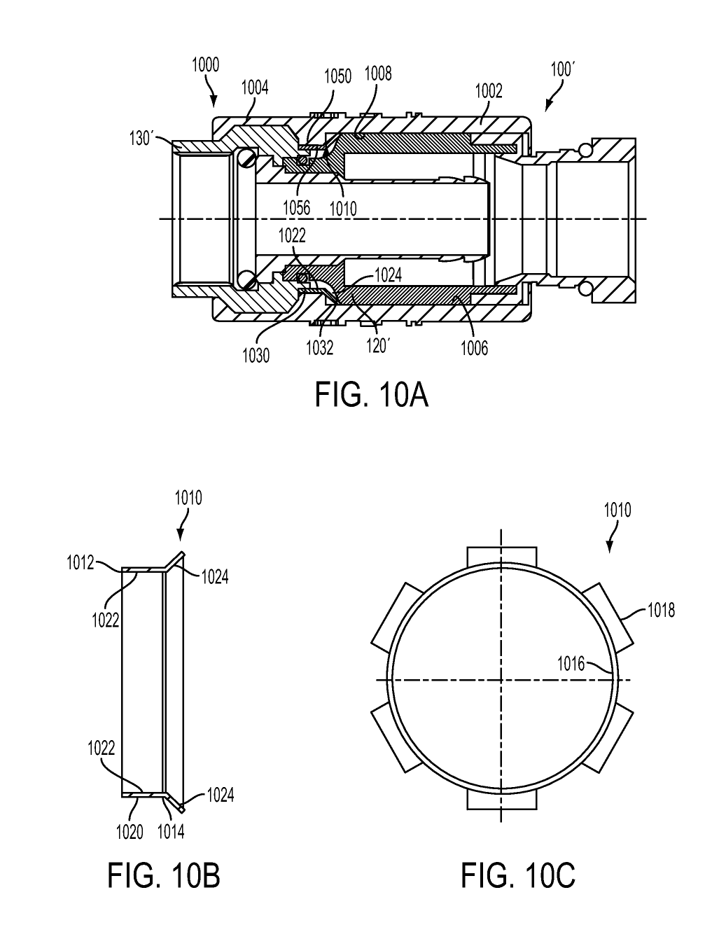

FIGS. 10A-10D illustrate a fourth embodiment of a gripping sleeve 1000 and integrated grounding member 1010. Like the gripping sleeves of the above embodiments, the gripping sleeve 1000 generally includes a main body 1002, an outer surface 1004, and an internal bore 1006 with an inner surface 1008 adapted to receive the connector 100′. The gripping sleeve 1000 may include a retaining member 1050 that is preferably an annular flange extending around the inner surface 1008 of the sleeve 1000. The flange 1050 may be continuous or discontinuous. The flange 1050 may have an annular inner surface 1056 that extends into the gap between the body 120′ and the nut 130′ when the sleeve 1000 is installed on the connector. The flange 1050 preferably has a grounding area portion that supports the grounding member 1010, as seen in FIG. 10A.

The grounding member 1010 is formed of a conductive material and generally includes a ring body 1016 (FIG. 10B) with opposite first and second ends 1012 and 1014 and a plurality of resilient fingers 1018 (FIG. 10C) extending from the second end 1014. The outside of the ring body 1016 includes a sleeve engaging surface 1020 that rests on the annular inner surface 1056 of the sleeve's flange 1050. The grounding member 1010 is held on the flange 1050 in any known manner, such as overmolding, interlocking, press-fit, adhesive, and the like.

The inside of the ring body 1016 of the grounding member 1010 includes a nut contact surface 1022 such that when the sleeve 1000 is installed on the connector, the ring body 1016 is sandwiched between the inner surface 1008 of the sleeve 1000 and the free end of the nut 130′. Each of the fingers 1018 of the grounding member 1010 includes a body contact surface 1024 on the ends. The length of the grounding member 1010 is sized so that the when fitted in the gap, positive contact is made between the nut contact surface 1022 and the outer surface 1030 of the nut 130′ and between the body contact surfaces 1024 of the fingers 1018 and the outer surface 1032 of the body 120′, as best seen in FIG. 10A.

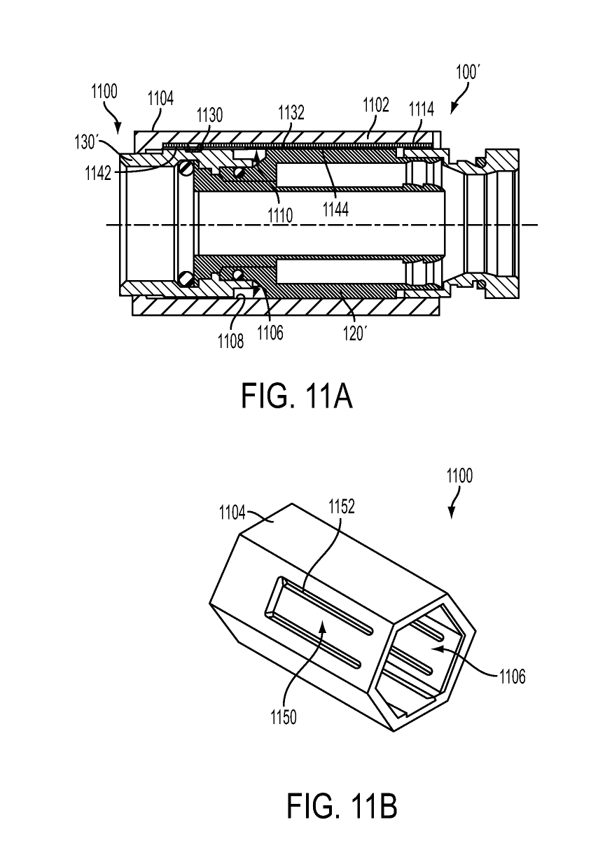

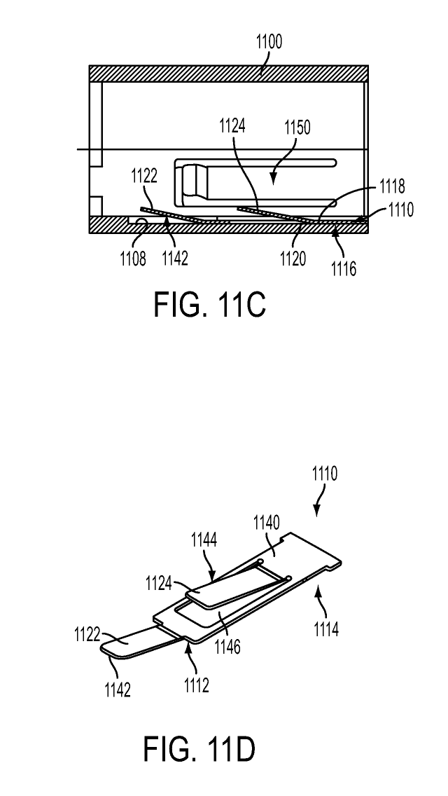

FIGS. 11A-11D illustrate a fifth embodiment of a sleeve 1100 and a grounding member 1110 integrated therein. The sleeve 1100 and the grounding member 1110 function similarly to the above embodiments in facilitating gripping and providing a conductive path between the nut 130′ and the body 120′.

As seen in FIG. 11B, the gripping sleeve 1100 generally includes a main body 1102, an outer surface 1104 that facilitates gripping of the connector and an internal bore 1106 adapted to receive the connector. The walls of the sleeve 1100 may include one or more resilient tabs 1150 (FIG. 11B) that each has a lip 1152 on the end thereof extending into the internal bore 1106. The inner surface 1108 of the internal bore 1106 includes a grounding area portion for supporting the grounding member 1110.

As seen in FIGS. 11A, 11C, and 11D, the grounding member 1110 may include a main body 1140 (FIG. 11D) that is a metal segment with first and second ends 1112 and 1114 and opposite first and second sides 1116 and 1118. The first side 1116 includes a sleeve engaging surface 1120 that engages the inner surface 1108. The grounding member 1110 may include a first resilient tab 1142 (FIG. 11D) extending from the first end 1112 and a second resilient tab 1144 (FIG. 11D) extending from a cutout section 1146 of the main body 1140. A cutout section 1146 is sized to receive one of the tabs 1150 of the sleeve 1100 to retain the grounding member 1110 on the inside of the sleeve 1100. When the sleeve 1100 is installed on the connector, the first end 1112 of the grounding member 1110 is sandwiched between the outer surface of the nut 130′ and the inner surface 1108 of the sleeve 1100 and the second end 1114 is sandwiched between the outer surface of the body 120′ and the inner surface 1108 of the sleeve 1100.

The first resilient tab 1142 may include a nut contact surface 1122 on the inside thereof and the second resilient tab 1144 may include a body contact surface 1124 on the inside thereof, as seen in FIGS. 11C and 11D. The length of the grounding member 1110 should be long enough so that the tabs 1142 and 1144 can contact the nut 130′ and the body 120′, respectively. In this embodiment, the nut contact surface 1122 engages an outer surface 1130 of the nut 130′ and the body contact surface 1124 engages an outer surface 1132 of the connector body 120′, as best seen in FIG. 11A.

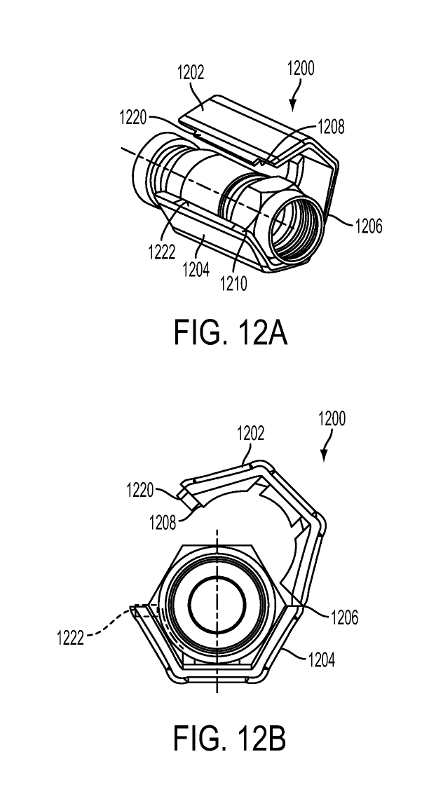

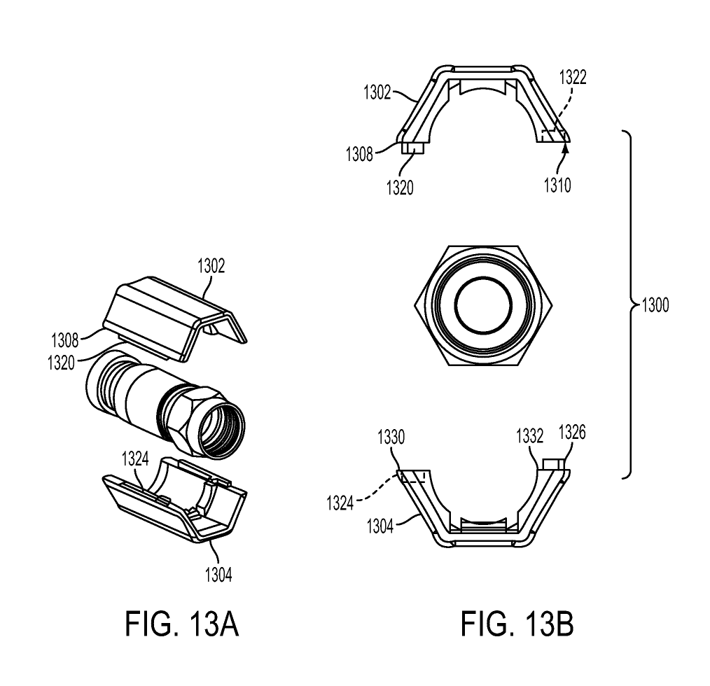

While the gripping sleeves of the above embodiments may be formed as one-piece, the gripping sleeves may alternatively be formed of two pieces to facilitate assembly with the electrical connector, as illustrated in the embodiments of FIGS. 12A-12B and 13A-13B. The gripping sleeves of all of the embodiments may be made of a plastic material. Alternatively, the gripping sleeves may formed of metal or metalized plastics, such that the inner surface of the sleeve contacts the nut and the body of the connector to form the grounding path. In such an embodiment, the need for a separate grounding member can be eliminated. In yet another embodiment, all or portions of the inner surface of the gripping sleeve may be plated or otherwise coated or covered in a conductive material or the gripping sleeve may be partially or completely comprised of a conductive material, to provide the grounding area portion and grounding path between the nut and the body.

FIGS. 12A and 12B illustrate a sixth embodiment of a gripping sleeve 1200 according to the present invention that generally includes first and second pieces 1202 and 1204 hinged together at a hinge 1206. The first and second pieces 1202 and 1204 are adapted to mate via alignment member 1220 and 1222, respectively. For example, the alignment member 1220 on the first piece 1202 may be a key extending for at least part of the length of the piece 1202 at an edge 1208 thereof and the alignment member 1222 may be a corresponding slot formed in the edge 1210 of the second piece 1204. The electrical connector may be retained in the gripping sleeve 1200 when the key 1220 of the first piece 1202 is received in the slot 1222 of the second piece 1204. Alternatively, the key may be provided on the second piece 1204 and the slot in the first piece 1202. The key 1220 and the slot 1222 may have any shape as long as the shapes thereof correspond to each other for mating alignment. The alignment members may also be eliminated such that the edges of the first and second pieces 1202 and 1204 opposite the hinge 1206 are secured together in any known manner, such as adhesive.

FIGS. 13A and 13B illustrate a seventh embodiment of a gripping sleeve 1300 according to the present invention. Similar to the gripping sleeve 1200, the gripping sleeve 1300 includes first and second pieces 1302 and 1304. Unlike the gripping sleeve 1200, the pieces 1302 and 1304 of the gripping sleeve 1300 are not hinged together and are separate. Instead of a hinge, corresponding alignment members are provided at both ends of the pieces 1302 and 1304. For example, the first piece 1302 may have a first alignment member 1320, such as a key, at a first end edge 1308 and a second alignment member 1322, such as a slot, at the opposing second end edge 1310. The second piece 1304 may likewise have a third alignment member 1324, such as a slot, at a first end edge 1330 and a fourth alignment member 1326, such as a key, at the opposing second end edge 1332. The electrical connector is retained in the gripping sleeve 1300 when the first and third alignment members 1320 and 1324, e.g. key and slot, are engaged, and the second and fourth alignment members 1322 and 1326 are likewise engaged. The alignment members may also be eliminated such that the first edges 1308 and 1330 of the two pieces 1302 and 1304 and their second edges 1310 and 1332 are secured together in any known manner, such as adhesive.

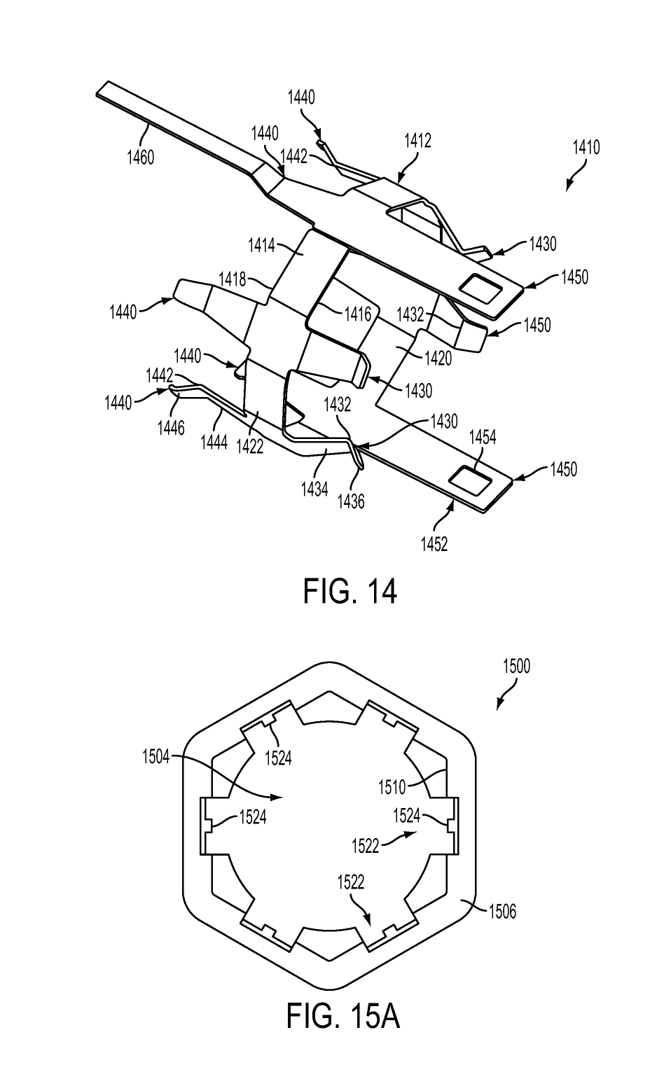

FIGS. 14, 15A, 15B, 16A, 16B, and 17-19 illustrate yet another grounding member 1410 that is incorporated into a gripping sleeve 1500 according to an eighth exemplary embodiment of the present invention. The grounding member 1410 and the gripping sleeve 1500 are designed to facilitate automation of the assembly and manufacture of the connector 100″ including the assembly of the grounding member 1410 and the sleeve 1500.

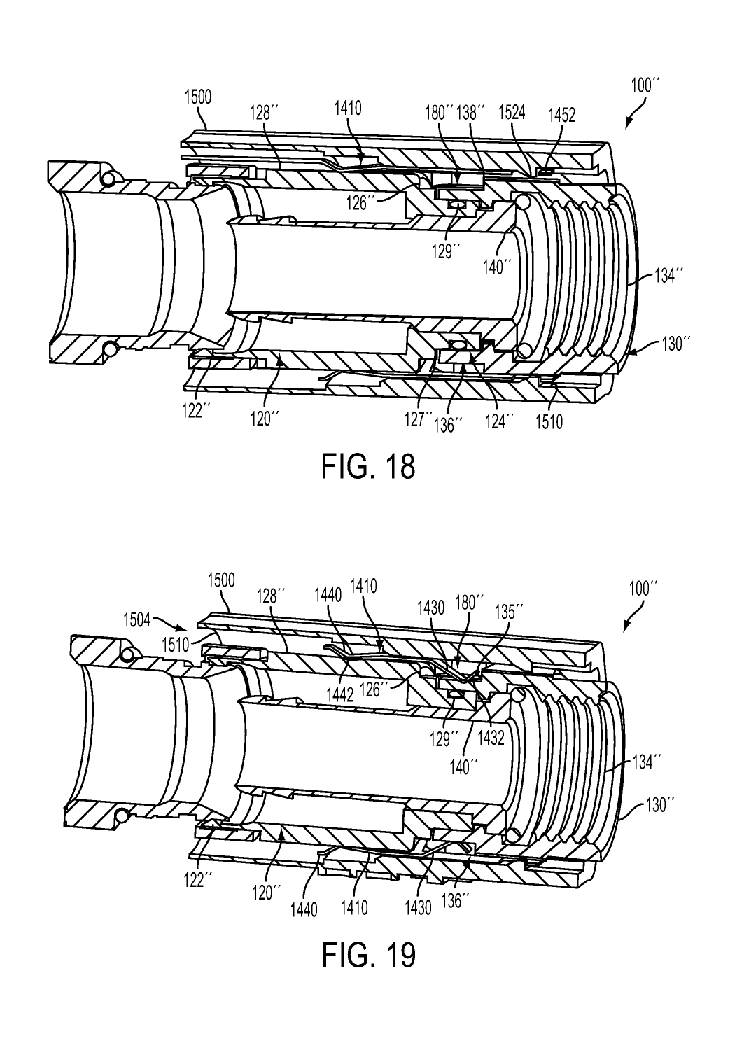

The connector 100″ is similar to connectors 100 and 100′ in that it includes a body 120″, a coupling member or nut 130″, and a post member 140″. The body 120″ includes a first end 122″ that terminates to a prepared end of the cable and an opposite second end 124″ that engages the nut 130″. The body 120″ includes an annular shoulder 126″ near the second end 124″ and an annular outer surface 128″. The annular outer surface 128″ of the body 120″ is preferably not covered by any portion of the nut 130″. The second end 124″ may include a stepped surface 127″ that has a groove for accommodating a sealing ring 129″. The nut 130″ includes an interface end 134″ for engaging the mating connector and an opposite end 136″, which may overlap a portion of the second end 124″ of the body 120″, such as at the stepped surface 127″, thereby sandwiching the sealing ring 129″ therebetween (FIGS. 18 and 19). The nut 130″ includes an annular shoulder 138″. A gap 180″ is defined between the annular shoulder 126″ of the body 120″ and the annular shoulder 138″ of the nut 130″ for accommodating arms of the grounding member 1410 as described below.

As best seen in FIGS. 14 and 17, the grounding member 1410 includes a conductive body 1412 that generally has a ring portion 1414 and a plurality of resilient arms 1430 and 1440. The grounding member 1410 is preferably formed by stamping the conductive body 1412 from sheet metal and forming the same. The ring portion 1414 includes opposite front and rear edges 1416 and 1418 and opposite inner and outer surfaces 1420 and 1422. The front edge 1416 faces toward the coupling member 130″ of the connector 100″ and the inner surface 1420 faces toward the body 120″ of the connector 100″, as seen in FIG. 17. Extending from the front edge 1416 of the ring portion 1414 is the first set of resilient arms 1430. Each of the resilient arms 1430 includes a coupling member contact surface 1432 for engaging an outer surface 135″ of the coupling member 130″, preferably in the gap 180″ behind the nut's annular shoulder 138″. Each arm 1430 may include a tapered lead-in portion 1434 that tapers inwardly and a free end portion 1436 angled therefrom. The lead-in portion 1434 and the free end portion 1436 define a generally V-shaped bend at the intersection thereof at which the coupling member contact surface 1432 is preferably located.

A second set of resilient arms 1440 extends from the rear edge 1418 of the ring portion 1414 of the grounding member 1410. Each arm 1440 includes a body contact surface 1442 configured to contact the annular outer surface 128″ (FIG. 17) of the body 120″ of the connector 100″. In a preferred embodiment, the body contact surface 1442 of the grounding member 1410 contacts the body's annular outer surface 128″ behind its annular shoulder 126″. Similar to the first set of resilient arms 1430, each of the arms 1440 of the second set includes an inwardly tapered lead-in portion 1444 and a free end portion 1446. The lead-in portion 1444 and the free end portion 1446 intersect at a generally V-shaped bend at which body contact surface 1442 is preferably located. In a preferred embodiment, individual arms of the first and second sets of arms 1430 and 1440 are axially aligned such that they extend opposite one another and are spaced around the ring portion 1414, as seen in FIG. 14.

One or more sleeve engagement members 1450 may extend from the front edge 1416 of the ring portion 1414 of the grounding member 1410. Each engagement member 1450 may be an extension with an engagement portion 1452 at a distal end thereof that is configured to engage the gripping sleeve 1500. The engagement portion 1452 may include, for example, a latch opening 1454. In a preferred embodiment, two engagement members 1450 are provided that are spaced about 180 degrees apart on the ring portion 1414. One of the resilient arms of the second set of arms 1440 may extend from the opposite edge of each the engagement members 1450, such that the engagement members 1450 are axially aligned with the arms 1440. FIG. 14 illustrates the preferred embodiment of the grounding member 1410 as having four resilient arms 1430 extending from the front edge 1416, six resilient arms 1440 extending from the rear edge 1418, and two engagement members 1450 extending from the front edge 1416, where the arms 1430 and 1440 are aligned with one another and the engagement members 1450 and the arms 1440 are aligned with one another. However, the grounding member 1410 may have any number of arms 1430 and 1440 and engagement members 1450 which may or may not be aligned with one another, as long as at least one coupling member contact surface 1432 and at least one body contact surface 1442 is provided to define a grounding path between the body 120″ and the nut 130″ through the grounding member 1410. A carrier strip tab 1460 may be provided on one of the arms 1440 that connects to a carrier strip when stamping the grounding member 1410. The grounding member 1410 is cut from the carrier strip at the tap 1460.

The gripping sleeve 1500 is similar to the gripping sleeves of the previous embodiments in that it includes a main body 1502 with an internal bore 1504 that accommodates portions of the body 120″ and the nut 130″. A front end 1506 of the gripping sleeve 1500 is near the nut 130″ when assembled on the connector 100″ and the rear end 1508 is opposite the front end 1506. The inner surface 1510 defining the internal bore 1504 engages with the nut 130″ such that the sleeve 1500 and the nut 130″ rotate together. The inner surface 1510 also supports the grounding member 1410 such that the grounding member 1410 is sandwiched between the sleeve 1500 and the connector 100″, as seen in FIGS. 18 and 19.

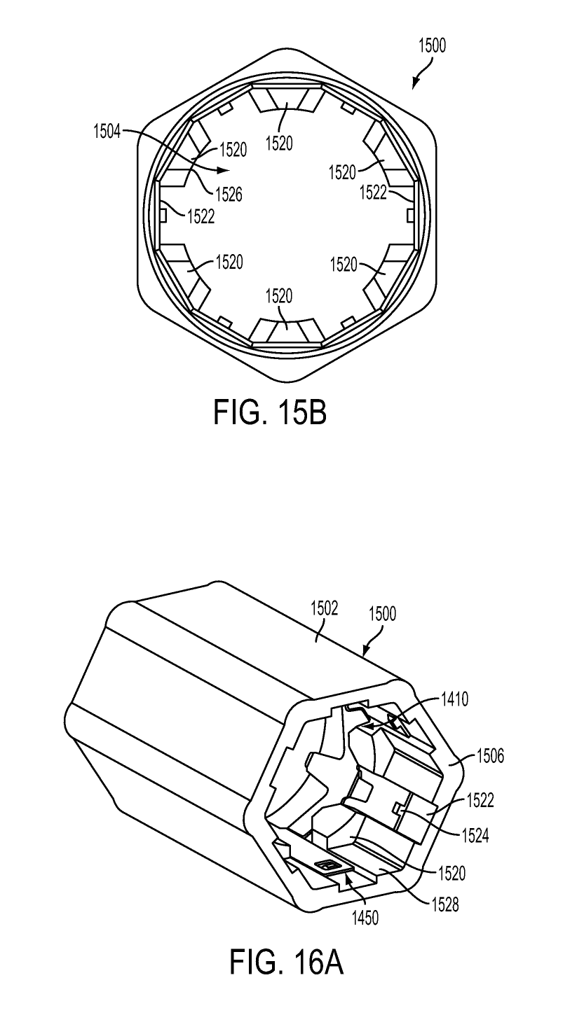

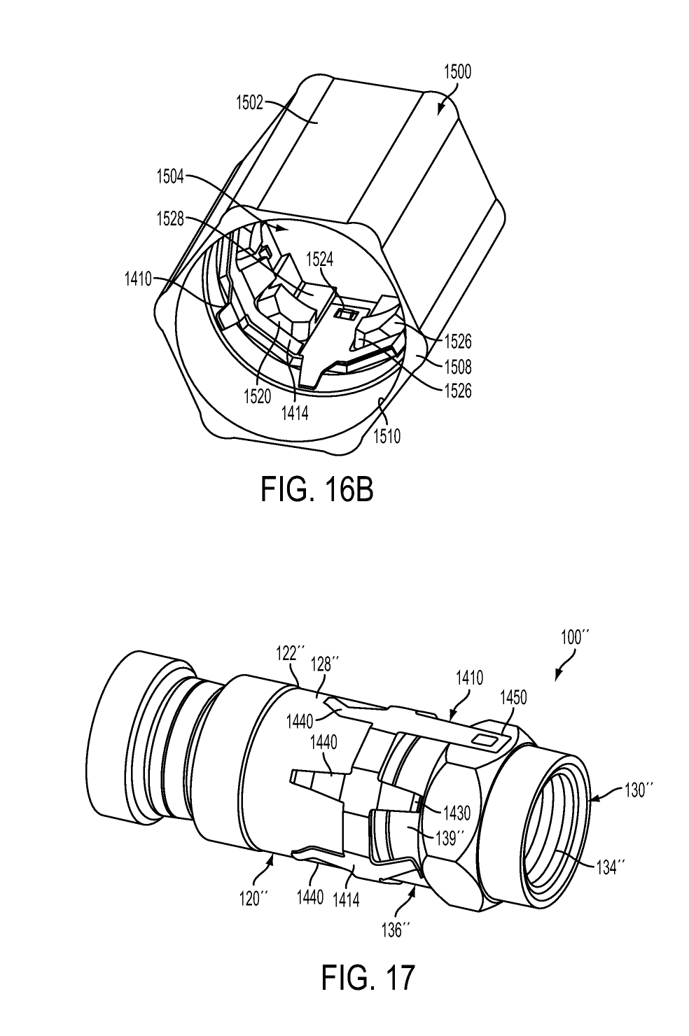

As best seen in FIGS. 15A, 15B, 16A, and 16B, the gripping sleeve 1500 includes a number of inwardly extending protrusions 1520. The protrusions 1520 are preferably uniformly spaced around the inner surface 1510. Each of the protrusions 1520 engages is captivated in the gap 180″ (FIGS. 18 and 19) to retain the coupling sleeve 1500 axially on the connector assembly. Slots 1522 formed between each of the protrusions 1520 are sized to accommodate the extensions of the sleeve engagement members 1450 of the grounding member 1410 and act as a guide for the engagement members 1450 when assembling the grounding member 1410 with the sleeve 1500. Each slot 1522 includes an engagement portion 1524, such as a barb, that corresponds to the engagement portion 1452 of the sleeve engagement members 1450 of the grounding member 1410. In a preferred embodiment, the latch openings 1454 of the sleeve engagement members 1450 capture the barbs 1524 on the inner surface 1510 of the sleeve 1500. However, any known engagement may be used to assemble the grounding member 1410 to the inner surface 1510 of the sleeve 1500. Each protrusion 1520 may also include a chamfer 1526 that functions to lead in the grounding member 1410 if the grounding member 1410 is not clocked perfectly during assembly with the sleeve. Behind the protrusions 1520 is a generally hexagonally shaped cavity 1528 (FIG. 16B) defined along the inner surface of the sleeve 1500, which engages the nut 130″, preferably at its hexagonal flats, with a press or slip-type fit. The cavity 1528 essentially keys the sleeve 1500 to the nut 130″ to translate rotation or torque from the sleeve 1500 to the nut 130″.

To assemble the connector 100″, the grounding member 1410 is first assembled to the sleeve 1500. The grounding member 1410 is inserted into the rear end 1508 of the sleeve 1500 by axially inserting the sleeve engagement members 1450 and the first set of resilient arms 1430 into the internal bore 1504. The grounding member 1410 moves axially into the sleeve's internal bore 1504 until the sleeve engagement members 1450 interlock with the engagement members 1524 on the inner surface 1510 of the sleeve and the front edge 1416 of the ring portion 1414 abuts the protrusions 1520. The slots 1522 between the protrusions 1520 guide the sleeve engagement members 1450 until the engagement portions 1452 thereof, such as a detent opening, interlocks with one of the corresponding engagement members, such as barbs 1524, on the inner surface 1510 of the sleeve 1500, as seen in FIG. 18. Because the sleeve's inner surface 1510 includes multiple and uniformly spaced barbs 1524, as best seen in FIGS. 15A and 15B, the sleeve engagement members 1450 of the grounding member 1410 may engage any one of those barbs, thereby facilitating assembly of the grounding member 1410 with the sleeve 1500.

After assembling the grounding member 1410 and the sleeve 1500, the connector 100″ can then be inserted into the internal bore 1504 of the sleeve 1500 such that the grounding member 1410 is sandwiched therebetween. In a preferred embodiment, the connector body 120″ of the connector 100″ is inserted through the rear end 1508 of the sleeve 1500 and the nut 130″ of the connector 100″ is inserted through the front end 1506 of the sleeve 1500. The body 120″ and 130″ are then connected to one another. In an alternative embodiment, the subassembly of the grounding member 1410 and sleeve 1500 can be slid onto the connector 100″ and held in place by a snapping engagement, for example. Once assembled, the grounding member 1410 acts as a grounding path between the body 120″ and the nut 130″ through the body contact surface 1442 and the coupling member contact surface 1432, as seen in FIG. 19.

While particular embodiments have been chosen to illustrate the invention, it will be understood by those skilled in the art that various changes and modifications can be made therein without departing from the scope of the invention as defined in the appended claims. For example, one or more grounding members of the above embodiments may be provided inside the sleeve to provide a conductive grounding path between the nut and connector. Also, the length of the grounding members of the above embodiments may vary as long as the grounding member contacts the outer surface of both the nut and the body.

What is claimed is:

1. A grounding member for an electrical connector, comprising:
a conductive body, said body including:
a ring portion having opposite front and rear edges, said front edge being configured to face a coupling member of the electrical connector, and opposite inner and outer surfaces, said inner surface being configured to face a body of the electrical connector,
at least a first resilient arm extending from said front edge of said ring portion, said first resilient arm having a coupling member contact surface configured to contact the coupling member of the electrical connector,
at least a second resilient arm extending from said rear edge of said ring portion, said second resilient arm having a body contact surface configured to contact the body of the electrical connector, and
at least one sleeve engagement member extending from said ring portion configured to engage a gripping sleeve.

2. A grounding member according to claim 1, wherein
said first and second resilient arms are axially aligned.

3. A grounding member according to claim 1, wherein
each of said first and second resilient arms has a tapered lead-in section and an angled free end section;
said coupling member contact surface is located at said intersection of said tapered lead-in section and said angled free end section of said first resilient arm; and
said body contact surface is located at said intersection of said tapered lead-in section and said angled free end section of said second resilient arm.

4. A grounding member according to claim 2, wherein
said sleeve engagement member is spaced from said first and second resilient arms.

5. A grounding member according to claim 4, wherein
said sleeve engagement member extending from said front edge of said ring portion.

6. A grounding member according to claim 5, further comprising
a second sleeve engagement member extending from said ring portion.

7. A grounding member according to claim 6, wherein
said sleeve engagement members are arranged 180 degrees apart.

8. A grounding member according to claim 7, wherein
said sleeve engagement member includes a carrier strap tab.

9. A grounding member according to claim 5, further comprising
a plurality of resilient arms extending from said front edge of said ring portion; and
a plurality of resilient arms extending from said rear edge of said ring portion.

10. A grounding member according to claim 9, wherein
said plurality of resilient arms extending from said front edge are spaced from one another; and
said plurality of resilient arms extending from said rear edge are spaced from one another.

11. A grounding member and gripping sleeve assembly, comprising:
a sleeve having front and rear ends and an internal bore, said internal bore including at least one grounding engagement member; and
a conductive body, said body including:
a ring portion having opposite front and rear edges, said front edge being configured to face said front end of said sleeve, and opposite inner and outer surfaces,
at least a first resilient arm extending from said front edge of said ring portion, said first resilient arm having a first contact surface,
at least a second resilient arm extending from said rear edge of said ring portion, said second resilient arm having a second contact surface, and
at least one sleeve engagement member extending from said ring portion,
wherein said at least one grounding engagement member of said sleeve engaging said at least one sleeve engagement member of said conductive body.

12. A grounding member and gripping sleeve assembly according to claim 11, wherein
said first and second resilient arms are axially aligned.

13. A grounding member and gripping sleeve assembly according to claim 11, wherein
each of said first and second resilient arms has a tapered lead-in section and an angled free end section;
said first contact surface is located at said intersection of said tapered lead-in section and said angled free end section of said first resilient arm; and
said second contact surface is located at said intersection of said tapered lead-in section and said angled free end section of said second resilient arm.

14. A grounding member and gripping sleeve assembly according to claim 11, wherein
said sleeve engagement member is spaced from said first and second resilient arms.

15. A grounding member and gripping sleeve assembly according to claim 11, wherein
said sleeve engagement member extending from said front edge of said ring portion.

16. A grounding member and gripping sleeve assembly according to claim 11, further comprising
a plurality of resilient arms extending from said front edge of said ring portion; and
a plurality of resilient arms extending from said rear edge of said ring portion.

17. An electrical connector, comprising:
a connector body having opposite first and second ends, said second end being configured to be coupled with a prepared end of a cable;
a coupling member having an interface end configured to interface with a mating connector and an opposite end that is rotatable with respect to said connector body;
a gripping sleeve coupled to an outer surface of said coupling member such that said gripping sleeve and coupling member rotate together, said gripping sleeve having a main body with an internal bore configured to accommodate at least a portion of said coupling member and said connector body, an outer surface providing a gripping area portion, and an inner surface opposite said outer surface; and
a conductive grounding member received in said internal bore of said gripping sleeve, said grounding member including:
a ring portion having opposite first and second edges, said first edge facing said coupling member, and opposite inner and outer surfaces, said inner surface facing said connector body,
at least a first resilient arm extending from said first edge of said ring portion, said first resilient arm having a coupling member contact surface contacting said coupling member,
at least a second resilient arm extending from said second edge of said ring portion, said second resilient arm having a body contact surface contacting said connector body, and
wherein said grounding member creates a grounding path between said connector body and said coupling member.

18. An electrical connector according to claim 17, wherein
said grounding member includes at least one sleeve engagement member that extends from said ring portion configured to engage a corresponding engagement member on said gripping sleeve.

19. An electrical connector according to claim 18, wherein
said sleeve engagement member of said grounding member extends from said front edge of said ring portion; and
said engagement member of said gripping sleeve is disposed on said inner surface thereof.

20. An electrical connector according to claim 19, wherein
said sleeve engagement member includes a detent opening and said engagement member of said gripping sleeve includes a detent.

21. An electrical connector according to claim 19, wherein
said gripping member includes a plurality of engagement members disposed on said inner surface, each of said plurality of engagement members being configured to engage said sleeve engagement member of said grounding member.

22. An electrical connector according to claim 17, wherein
said opposite end of said coupling member overlaps a portion of said first end of said connector body, said coupling member contact surface contacts said coupling member at said overlap.

23. An electrical connector according to claim 17, wherein
said coupling member includes an annular shoulder near said opposite end; and
said coupling member contact surface contacts said coupling member behind said annular shoulder.

24. An electrical connector according to claim 17, wherein
said body contact surface contacts said connector body at an annular outer surface thereof that is not overlapped by said coupling member.

25. An electrical connector according to claim 17, wherein
said connector body includes an annular shoulder, and said body contact surface contacts said annular outer surface behind said annular shoulder.

26. An electrical connector according to claim 17, wherein
each of said first and second resilient arms has a tapered lead-in section and an angled free end section;
said coupling member contact surface is located at said intersection of said tapered lead-in section and said angled free end section of said first resilient arm; and
said body contact surface is located at said intersection of said tapered lead-in section and said angled free end section of said second resilient arm.

27. An electrical connector according to claim 17, wherein
a plurality of resilient arms extend from said front edge of said ring portion of said grounding member; and
a plurality of resilient arms extend from said rear edge of said ring portion of said grounding member.

28. An electrical connector according to claim 17, further comprising
a post member that is insertable into said connector body for coupling to a prepared end of the cable; and
said coupling member being rotatably coupled to an end of said post member.

29. A method of assembling an electrical connector, comprising the steps of:
providing an electrical connector including a connector body and a coupling member rotatable with respect to the connector body;
providing a gripping sleeve including an internal bore that is configured to receive a portion of the connector body and the coupling member, the internal bore includes at least one engagement member, and the gripping sleeve includes opposite front and rear ends;
providing a conductive grounding member including,
a ring portion having opposite front and rear edges, the front edge being configured to face a coupling member of the electrical connector, and opposite inner and outer surfaces, the inner surface being configured to face a body of the electrical connector,
at least a first resilient arm extending from the front edge of the ring portion, the first resilient arm having a coupling member contact surface configured to contact the coupling member of the electrical connector,
at least a second resilient arm extending from the rear edge of the ring portion, the second resilient arm having a body contact surface configured to contact the body of the electrical connector, and
at least one sleeve engagement member extending from the ring portion
inserting the grounding member into the rear end of the gripping sleeve until the at least one engagement member of the gripping sleeve interlocks with the at least one sleeve engagement member of the grounding member
inserting the electrical connector into the internal bore of the gripping sleeve such that the grounding member contacts an outer surface of the coupling member and an outer surface of the connector body.

30. A method according to claim 29, wherein
the step of inserting the electrical connector into the internal bore includes inserting the coupling member through front end of the gripping sleeve and inserting the connector body through rear end of the gripping sleeve.

31. A method according to claim 29, wherein
the step of inserting the electrical connector into the internal bore includes sliding the gripping sleeve over the electrical connector.

32. A method according to claim 29, further comprising the steps of
providing the gripping sleeve with a plurality of engagement members; and
interlocking the at least one sleeve engagement member of the grounding member with one of the plurality of engagement members.

33. A method according to claim 29, wherein
the grounding member includes a plurality of resilient arms extending from the front edge of the ring portion, and a plurality of resilient arms extending from said rear edge of said ring portion.

34. A method according to claim 29, wherein
the grounding member includes a plurality of sleeve engagement members.
